(19) United States
(12) Patent Application Publication
(10) Pub. No.: US 2005/0119013 A1
(43) Pub. Date: Jun. 2, 2005

(54) Mobile telecommunication system and method using separate subscriber location information

(76) Inventor: Eui-Jong Jeong, Gangwon-do (KR)

Correspondence Address: LADAS & PARRY LLP, 224 SOUTH MICHIGAN AVENUE, SUITE 1200, CHICAGO, IL, 60604, US

(21) Appl. No.: 10/498,774

(22) PCT Filed: Jul. 8, 2002
(86) PCT No.: PCT/KR02/01290

(30) Foreign Application Priority Data
Dec. 21, 2001 (KR) 2001-0082445

(51) Int. Cl. H04Q 7/20

(52) U.S. Cl. 455/456.5

(57) ABSTRACT

A mobile communication system using separate subscriber location information includes a Base Station Transceiver System(BTS)(20) for wireless communication with Mobile Systems(MS)(10), a Base Station Controller(BSC)(30) for operating and controlling BTS(20), a Mobile Switching Center(MSC)(40) connected to BSC(30) to set a path for a call and a Visitor Location Register(VLR)(40) for temporarily storing subscriber location information of a MS which exchanges information with the MSC in a service area of the MSC, a Home Location Register(HLR)(50) connected to the MSC/VLR(40) to store service profiles of all registered subscribers, and a Middle Location Register(MLR)(60) connected to the MSC/VLR(40) to receive and store subscriber location information of the MS from the VLR. When a call signal is received from a MS, the MSC/VLR(40) requests subscriber location information from the MLR and then connects the call by using the subscriber location information.

### TECHNICAL FIELD

The present invention relates to mobile telecommunication system and method, and more particularly to mobile telecommunication system and method which registers location information of a subscriber mobile station into a separate register, thereby making it possible to telecommunicate without passing through a home location register.

### BACKGROUND ART

A cellular mobile telecommunication system is comprised of various system components for covering each telecommunication service area. Specifically, such a mobile telecommunication system includes Mobile Stations (MSs) of a subscriber scattered over the service area, a Base station Transceiver System (BTS) for communicating with the mobile stations by coding and decoding of wireless channels, a Base Station Controller (BSC) for operating and controlling base stations by matching them, and a Mobile Switching Center (MSC) for giving interworking between communication networks such as the mobile communication network or Public Switched Telephone Network (PSTN) by conducting the switching function.

In addition, the mobile telecommunication system further includes a Home Location Register (HLR) storing service profiles of a subscriber such as an Electronic Serial Number (ESN) of a terminal and supplementary service kinds as well as a Mobile Identification Number (MIN) of the subscriber; and a Visitor Location Register (VLR) for temporarily storing and managing the information related to Mobile Station (MS) of a visitor escaped from the home switching center.

In particular, the HLR stores and manages important data such as subscriber parameters, location information, access ability, basic service and supplementary service for all MS registered in its area and conducts a routing function for a called subscriber. Such HLR registers its location when the MS is initially powered on, and during a call, HLR connects a call to a switching center covering an area where a desired mobile station is located. In addition, the HLR accomplishes basic functions for the supplementary service such as Internet connection. Thus, the HLR is necessarily concerned in location registration and calling of the MS, which causes all loads according to telephone traffic to be focused on the HLR. Furthermore, the focused loads of basic call traffic on HLR brings about a limitation in constructing various supplementary service in spite that the request for supplementary service such as Internet connection or location information provision in addition to the basic calling service is gradually increased.

### DISCLOSURE OF INVENTION

The present invention is designed to solve the problems of the prior art, and therefore an object of the invention is to provide mobile telecommunication system and method which is capable of providing various supplementary service because of reducing loads in Home Location Register (HLR) by adopting a Middle Location Register (MLR) for separately registering and managing only the basic subscriber information required for calling.

In order to accomplish the above object, the prevent invention provides a mobile telecommunication system using separate subscriber location information, which includes: a Base station Transceiver System (BTS) for wireless communication with a Mobile Station (MS) by encoding and decoding of wireless channel and a Base Station Controller (BSC) for operating and controlling the BTS; a Mobile Switching Center (MSC) connected to the BSC for an exchanging function and establishing a path for a call by network interworking and a Visitor Location Register (VLR) for exchanging information with the MSC and temporarily storing subscriber location information and call service information of the MSs existing in a service area; a Home Location Register (MLR) connected to the MSC/VLR for storing service profiles of all registered subscribers; and a Middle Location Register (MLR) connected to the MSC/VLR (40) for storing subscriber location information of the MS received from the VLR, wherein, when a call signal of the MS is received, the MSC/VLR requests the subscriber location information to the MLR and then connects a call using the received subscriber location information.

According to a preferred embodiment of the present invention, the MLR includes a lowest rank MLR connected to a plurality of the VLRs for receiving and storing the subscriber location information from the VLRs; and a next higher rank MLR connected to a plurality of the lowest rank MLRs for receiving and storing the subscriber location information, wherein the MLR has a plurality of hierarchical structures from the next higher rank MLR to an uppermost rank MLR in the same way, and the uppermost rank MLRs are connected to a Main MLR (MMLR).

According to another aspect of the invention, there is also provided a mobile telecommunication method using a mobile telecommunication system including a Base station Transceiver System (BTS) for wireless communication with Mobile Stations (MS), a Mobile Switching Center/Visitor Location Register (MSC/VLR) for conducting an exchanging function with the MS via the BTS and storing information of the MSs, a Home Location Register (HLR) for storing service profiles of all registered subscribers, and a Middle Location Register for storing subscriber location information of the MS, which method includes the steps of: (a) transmitting the subscriber location information from the MSC/VLR to the MLR and storing the subscriber location information; (b) sending a call signal for an opponent Mobile Station (MS_2) from one Mobile Station (MS_1) via the BTS to one Mobile Switching Center/Visitor Location Register (MSC/VLR_1); (c) requesting subscriber location information of the MS_2 from the MSC/VLR_1 to the MLR; (d) the MLR searching the subscriber location information of the MS_2 and providing the subscriber location information to the MSC/VLR_1 in response to the request; (e) the MSC/VLR_1 transmitting a call signal to an opponent Mobile Switching Center/Visitor Location Register (MSC/VLR_2) according to the subscriber location information; (f) the MSC/VLR_2 calling the MS_2; and (g) making a call with the MS_1 when the MS_2 answers while the MSC/VLR_1 is connected with the MSC/VLR_2.

Preferably, the step (a) may include: (a1) transmitting a location registration message from the MS via the BTS to the MSC/VLR; (a2) requesting subscriber information from the MSC/VLR to the HLR; (a3) the HLR searching and providing the corresponding subscriber information to the MSC/VLR; (a4) storing subscriber location information and call service information of the MS in the VLR; (a5) transmitting the subscriber location information from the VLR to the MLR; and (a6) storing the subscriber location information transmitted from the MLR.

As an alternative, the step (a) may also include: (a1′) transmitting a location registration message from the MS via the BTS to the MSC/VLR; (a2′) requesting subscriber information from the MSC/VLR to the HLR; (a3′) the HLR notifying the MSC/VLR that there is no subscriber information; (a4′) requesting subscriber information from the MSC/VLR receiving the notice to a subscribing area HLR; (a5′) the subscribing area HLR searching and providing the corresponding subscriber information to the MSC/VLR; (a6′) storing subscriber location information and cal service information of the MS in the VLR; (a7′) transmitting the subscriber location information from the VLR to the MLR; and (a8′) storing the subscriber location information transmitted from the MLR.

According to a more preferable embodiment of the present invention, in case the MS moves from one Base station Transceiver System (BTS_1) to a new Base station Transceiver System (BTS_2), the mobile telecommunication method may further include the steps of transmitting information of the MS received in the BTS_2 to the MSC/VLR; and updating the subscriber location information of the VLR according to the transmitted information.

As another alternative, in case the MS moves from one Base station Transceiver System (BTS_1) to a new Base station Transceiver System (BTS_2), the mobile telecommunication method may further include the steps of: transmitting information of the MS received in the BTS_2 to a new Mobile Switching Center/Visitor Location Register (MSC/VLR_2); the MSC/VLR_2 requesting subscriber information to the MLR; the MLR searching the existing location information of the VLR for the MS; instructing the existing Mobile Switching Center/Visitor Location Register (MSC/VLR_1) to transmit the subscriber information according to the location information of the VLR; transmitting the subscriber information from the MSC/VLR_1 to the MSC/VLR_2 according to the instruction; storing new subscriber location information and call service information of the MS in the new Visitor Location Register (VLR_2) according to the transmitted information; and transmitting the new subscriber location information from the VLR_2 to the MLR and updating the subscriber location information.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic diagram showing a mobile telecommunication system according to a preferred embodiment of the present invention;

FIG. 2 shows an example of a hierarchical structure of a Middle Location Register (MLR) according to a preferred embodiment of the present invention;

FIG. 3 is a block diagram showing schematic configuration of MLR according to a preferred embodiment of the present invention;

FIG. 4 exemplarily shows information stored and registered in a Visitor Location Register (VLR) according to a preferred embodiment of the present invention;

FIG. 5 shows an example of a subscriber location information database of MLR according to a preferred embodiment of the present invention;

FIG. 6 is a flowchart for illustrating the process for a home subscriber to register location information into MLR according to a preferred embodiment of the present invention;

FIG. 7 is a flowchart for illustrating the process for a visitor to register location information into MLR according to a preferred embodiment of the present invention;

FIG. 8 is a flowchart for illustrating the calling process according to a preferred embodiment of the present invention; and

FIG. 9 is a flowchart for illustrating the process of updating location information according to the movement of a mobile station according to a preferred embodiment of the present invention.

### BEST MODES FOR CARRYING OUT THE INVENTION

Hereinafter, preferred embodiments of the present invention will be described in detail with reference to the accompanying drawings.

System Configuration

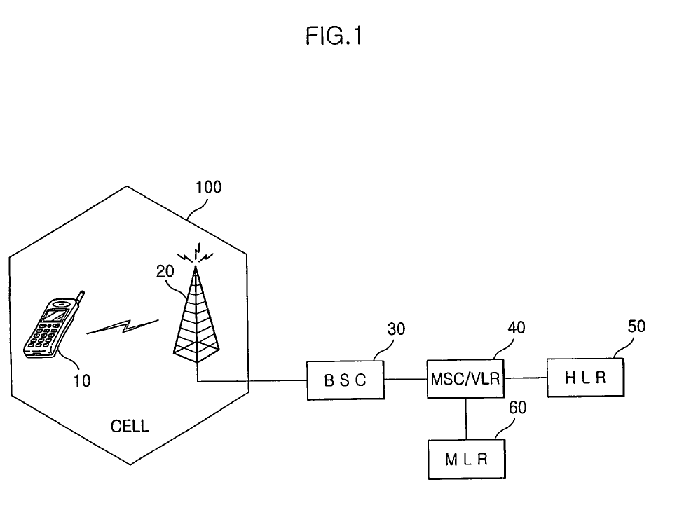

FIG. 1 shows a schematic configuration of a cellular mobile telecommunication system according to a preferred embodiment of the present invention. Referring to FIG. 1, the cellular mobile telecommunication system includes a Mobile Station (MS) 10 positioned in a cell 100, which is a service area, and a Base station Transceiver System (BTS) 20 for providing telecommunication service to subscribers by wireless communication with the MS 10. The BTS 20 performs transmitting/receiving signal strength control, bottom-up link quality measurement, space diversity function, wireless resource management and self-maintenance, as well known in the art.

A Basic Station Controller (BSC) 30 matches with a plurality of BTSs 20, and performs functions such as hand-off between cells, call control and base station operating and maintenance control.

The BSC 30 is connected to at least one Mobile Switching Center/Visitor Location Register (MSC/VLR) 40. The MSC acting for exchange establishes a path for a call by providing the interworking function between networks such as PSTN or mobile communication network and Internet. The MSC exchanges information with the VLR, and the VLR temporarily stores and manages information of all MSs existing in the service area.

As shown in FIG. 4 as an example, the VLR receives and stores subscriber location information 41 including a Mobile Identification Number (MIN), an Electronic Serial Number (ESN) of the MS and location information of the cell, and call service information 42 including a phone number of a caller, supplementary information such as Internet connection information, and information necessary for calling from a home location register described later.

In addition, the MSC/VLR 40 is connected to a Home Location Register (HLR) 50 and receives subscriber information related to call connection from the HLR 50. The HLR 50 is a database storing all service profiles of all subscribers such as a Mobile Identification Number (MIN), an Electronic Serial Number (ESN) of the MS and supplementary information. For example, the above-mentioned information may be transmitted through SS7 (Signaling System No.7) network between the MSC/VLR 40 and the HLR 50.

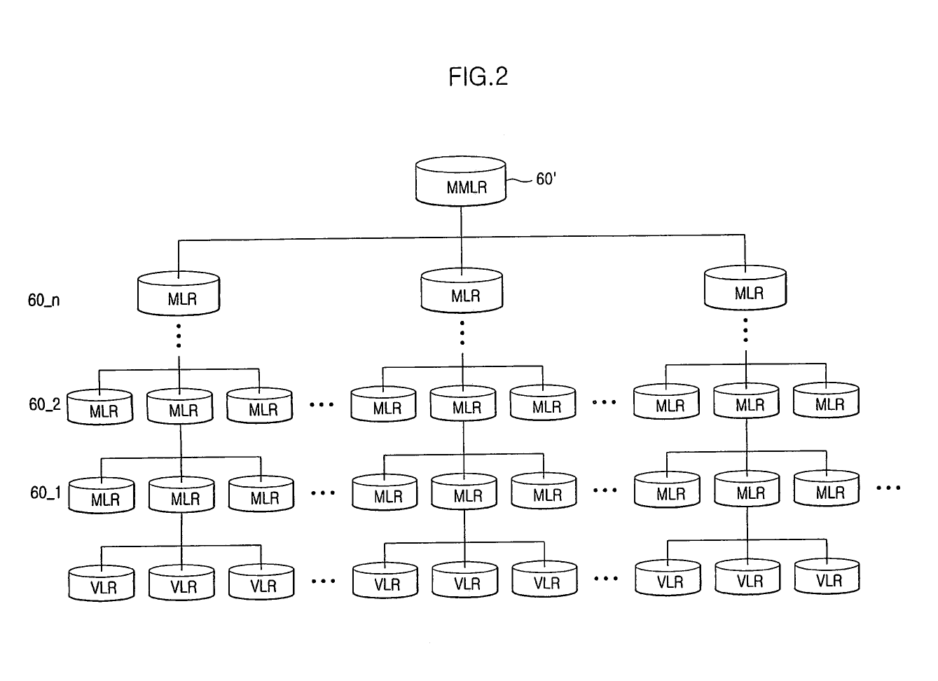

According to the present invention, the MSC/VLR 40 is connected to a Middle Location Register (MLR) 60. The MLR 60 is configured to be capable of matching and managing a plurality of MSC/VLRs 40 at the same time. For example, as shown in FIG. 2, a plurality of VLRs are connected to a first MLR 60_1, and a plurality of first MLRs 60_1 are again connected to a second MLR 60_2, which configures an upper group. The MLRs are hierarchically connected in such a way, and resultantly focused on a Main MLR (MMLR) 60′ through uppermost rank MLRs 60_{—}n.

The MLR receives and possesses the data from the VLR or a lower rank MLR under its control as they are. The MLRs are hierarchically organized in order to capture the service area step by step. For example, the first MLR 60_1 may possess location information of subscribers located in an area served by the MSC/VLR 40 (e.g., a street or a subdivision as an administrative division). In addition, the second MLR 60_2 in a higher group than the first MLR 60_1 may possess location information of subscribers located in a service area captured by the first MLR 60_1 connected to the second MLR 60_2 (e.g., a county or a district as an administrative division). In this way, as the MLR is in a higher rank, the MLR may possess subscriber location information in a broader area in common. Such a hierarchical structure enables to rapidly extract and provide subscriber location information during calling as described below.

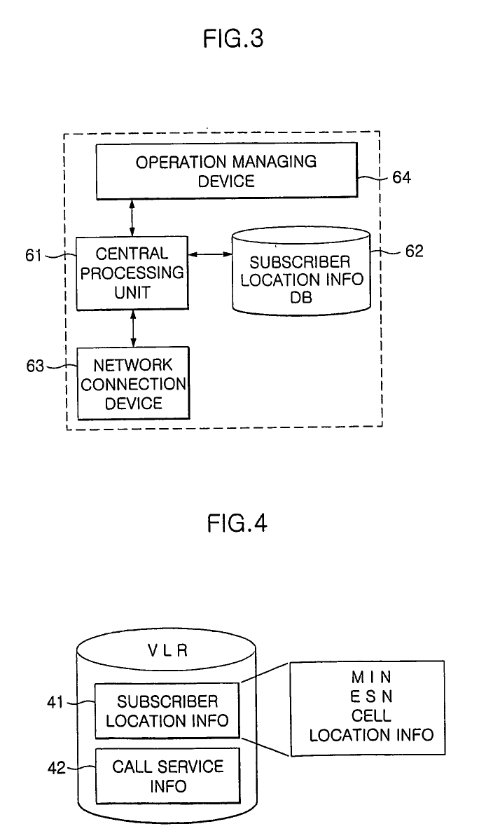

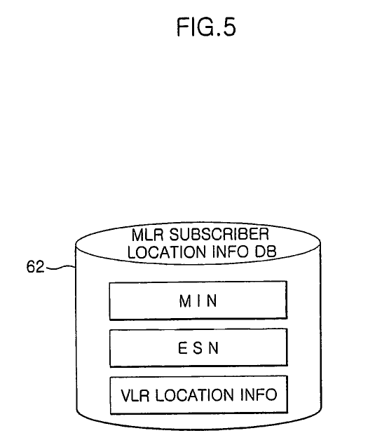

FIG. 3 is a block diagram schematically showing configuration of the MLR 60. Referring to FIG. 3, the MLR 60 includes a central processing unit 61 for playing roles of communication, and storage, search and provision of subscriber location information, and a subscriber location information DB 62 for recording and storing subscriber location information provided from the MSC VLR 40. The subscriber location information DB 62 stores ‘subscriber location information’ at the minimum such as a Mobile Identification Number (MIN) of a subscriber, an Electronic Serial Number (ESN) of the MS and location information of the VLR, which are provided from the VLR, as shown in FIG. 5.

In addition, the MLR 60 of the present invention further includes a network connection device 63 as a physical means for connecting to a network and communicating, and an operation managing device 64 having an input unit and a display for managing and operating the MLR 60.

Now, the process for registering location information of a subscriber by use of the above system and then executing the mobile telecommunication based on the subscriber location information is described.

Location Information Registration of Home Subscriber

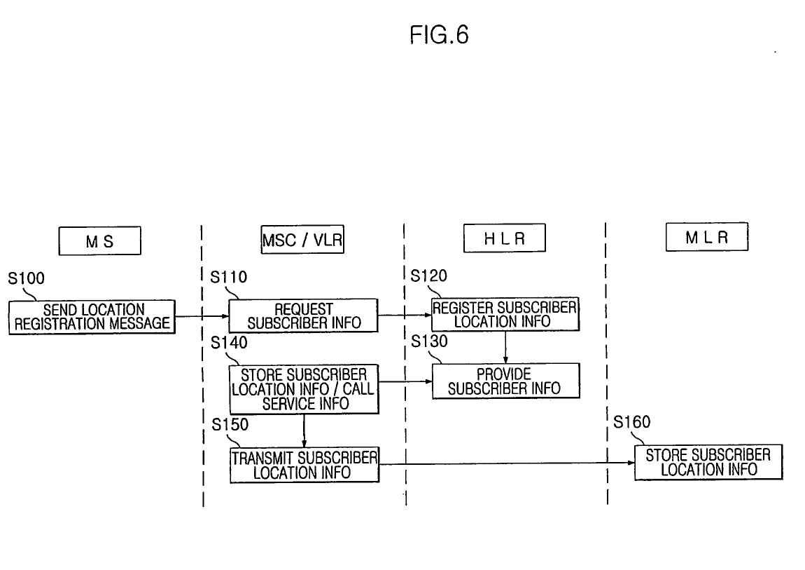

A subscriber initially registers location information of his/her own MS 10 (see FIG. 1) by using the system of the present invention as follows. FIG. 6 shows the process for a home subscriber to register its own location information.

First, when a home subscriber turns on the MS 10 in its own service area, a location updating message including a Mobile Identification Number (MIN), an Electronic Serial Number (ESN) is sent from the MS 10 (step S100). This location updating message is transmitted to the MSC/VLR 40 via the BTS 20 (See FIG. 1).

The MSC/VLR 40 transmits the MIN and the ESN to the HLR 50 and then requests subscriber information (step S110). On this, the HLR 50 registers location information of the subscriber corresponding to the MIN and the ESN by itself (step S120), and then searches information of the subscriber and provides it to the MSC/VLR 40 (step S130). The subscriber information provided as above is the call service information including essential information required for calling and information necessary for Internet service and caller phone number display service.

The MSC/VLR 40 stores the call service information 42 provided from the HLR 50 and the subscriber location information 41 including the MIN, the ESN and location information of the cell in the VLR as shown in FIG. 4 (step S140), and at the same time the MSC/VLR 40 adds identification information such as VLR_ID (i.e., location information of the VLR) and then transmits the subscriber location information to the MLR 60 connected thereto (step S150).

Subsequently, the MLR 60 stores and registers the transmitted subscriber location information (step S160). Preferably, such subscriber location information includes the MIN, the ESN and the VLR location information as shown in FIG. 5.

According to the present invention, the registration of the subscriber location information at the MLR 60 is repeatedly accomplished from the lowest rank MLR 60_1 till higher level MLRs 60_2˜60_{—}n and the Main MLR (MMLR) 60′ to which the lowest rank MLR 60_1 belongs. Thus, the same subscriber location information is all registered in from the lowest MLR 60_1 to the MMLR 60′ to which the corresponding VLR belongs. This characterizes the hierarchical structure of the MLR according to the present invention, and resultantly a MLR in a certain level possesses all location information of all lower rank MLRs belonged to the above MLR. Thus, as described later, in order to search location information of a subscriber not registered in a lower rank MLR, a next higher rank MLR is subsequently searched.

Location Information Registration of Visitor

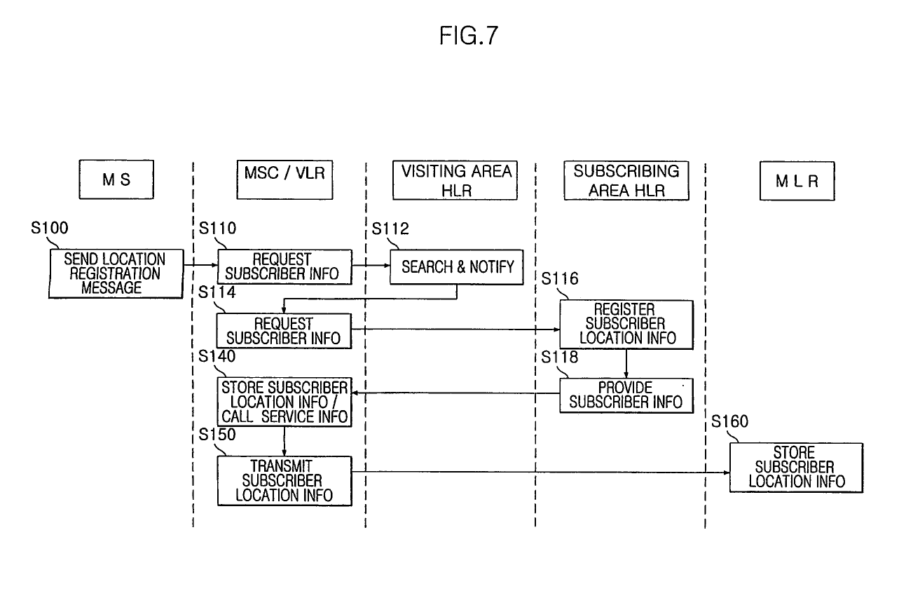

Now, the registration of location information in case the MS 10 escapes from its own home exchange station and becomes a visitor is described. This process is shown in FIG. 7. Here, the identical reference numeral to FIG. 6 shows the identical step, and not described in detail.

In the step S110, if the MSC/VLR requests subscriber information to its own HLR (i.e., a visiting area HLR in a standpoint of the MS), the visiting area HLR searches the database and then notifies that the MS is a visitor (step S112).

The MSC/VLR receiving the notice sends a subscriber information request message to the HLR to which the visitor belongs (i.e., a subscribing area HLR in a standpoint of the MS) using the routing information (a tracking route) stored in a Signaling Transfer Point (STP) (step S114). Then, the subscribing area HLR registers the location of the subscriber by itself as mentioned above (step S116), and then searches corresponding subscriber information and provides it to the MSC/VLR (step S118).

Subsequently, the following steps are identical to the former embodiment, and not described in detail. Now, the process for processing an outgoing/receiving call when the location information of the subscriber is registered as above is described.

Call Processing Process

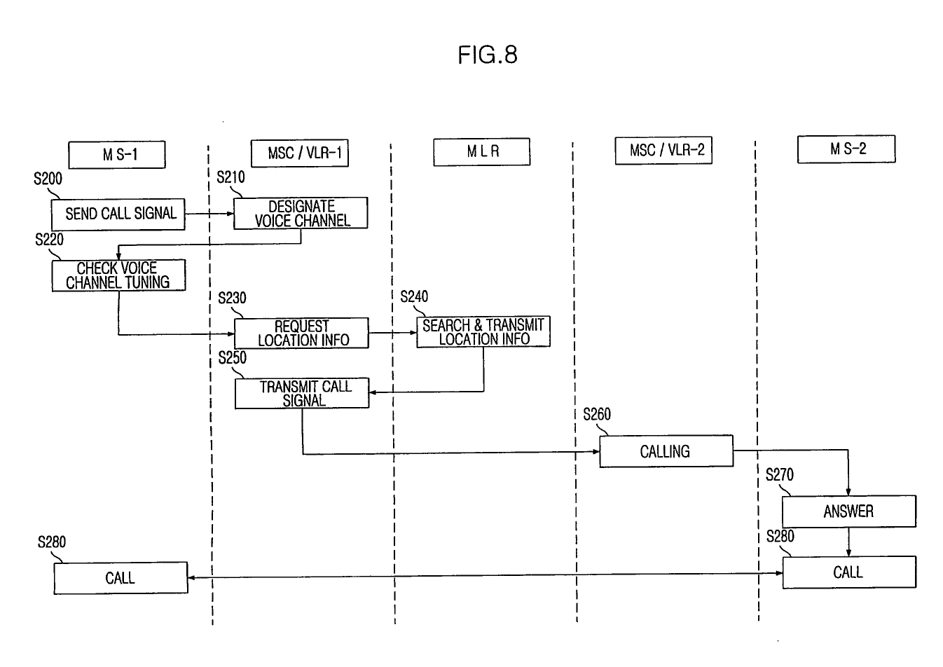

The call processing process according to the present invention is well shown in FIG. 8. FIG. 8 shows the process for a subscriber at one side to connect a call to a Mobile Station of an opponent subscriber (MS_2) by use of his/her own Mobile Station (MS_1). Referring to FIG. 8, if the mobile phone subscriber at one side inputs a phone number of the opponent in the MS_1 and pushes the SEND button, the MS_1 sends a call signal to the BTS 20 (see FIG. 1) through a previously established channel and this signal is again transmitted from the BTS 20 to the Mobile Switching Center/Visitor Location Register (MSC/VLR_1) through a data link (step S200).

Then, as well known in the art, the MSC/VLR_1 designates a voice channel for the MS_1 by controlling the BTS 20 (step S210), and accordingly the MS_1 answers to check the voice channel tuning (step S220).

Subsequently, the MSC/VLR_1 transmits a phone number of an opponent Mobile Station (MS_2) to the MLR to which it belongs in order to request the location information inquiry of the MS_2 (step S230).

On this, the MLR extracts location information of the MS_2 by searching the subscriber location information DB (see FIG. 5) and then provides the location information to the MSC/VLR_1 (step S240). This location information would include MIN of the opponent Mobile Station (MS_2), ESN and location information of the VLR where the station is located. Here, if the location information of the MS_2 is not registered in the first MLR 60_1 (see FIG. 2) at the lowest rank, the first MLR 60_1 requests the search to the second MLR 60_2 at the next higher rank possessing information for a broader area, and the second MLR 60_2 searches the location information and then provides it to the MSC/VLR_1. The MLRs at higher ranks are subsequently searched in such a way until the location information of the MS_2 is found out. The Main MLR (MMLR) in which the location information for all mobile stations are registered will be finally searched.

If receiving the location information of the MS_2 as above, the MSC/VLR_1 passes the call signal over an opponent Mobile Switching Center/Visitor Location Register (MSC/VLR_2) to which the opponent Mobile Station (MS_2) belongs (step S250).

Accordingly, the MSC/VLR_2 calls the MS_2 by designating a voice channel for the MS_2 through its own BTS and sending a ringing signal (step S260). On this, if a user of the MS_2 answers (step S270), the call is made with the MSC/VLR_1 and the MSC/VLR_2 being connected (step S280).

Location Information Updating During Movement

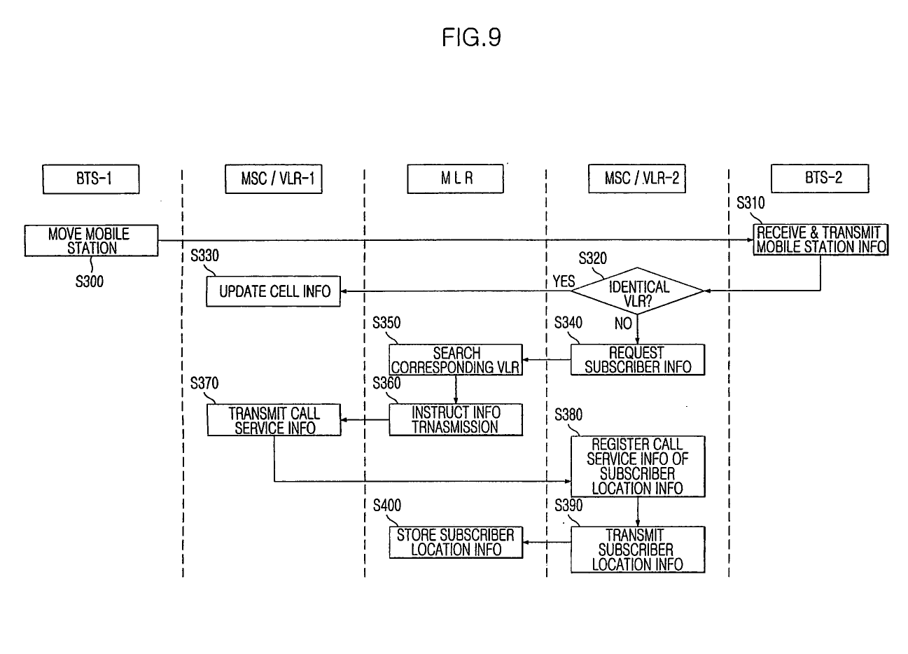

Now, the location information updating process in case a MS moves from one cell to another cell is described. This process is well shown in FIG. 9.

If the MS moves from a cell governed by one Base station Transceiver System (BTS_1) to another cell governed by a new Base station Transceiver System (BTS_2) (step S300), the BTS_2 receives specific terminal information from the MS and then transmits the information to its new Mobile Switching Center/Visitor Location Register (MSC/VLR_2) (step S310).

Then, the MSC/VLR_2 determines whether the MS is located within the same MSC/VLR (step S320). If the MS is located in the same MSC/VLR, in other words if the BTS_1 and the BTS_2 belong to the same MSC/VLR (this means the MSC/VLR_1 and the MSC/VLR_2 are identical), the MSC/VLR just updates cell location information 41 (see FIG. 4) of the VLR as the subscriber location information (step S330).

Or, if the MS belongs to the new Mobile Switching Center/Visitor Location Register (MSC/VLR_2), the MSC/VLR_2 requests subscriber information to a lowest rank MLR 60_1 (see FIG. 2) to which it belongs (step S340).

The lowest rank MLR 60_1 receiving the request searches the existing LVR location information (see FIG. 5) to which the corresponding MS belongs (step S350). If there does not exist the location information of the desired MS in the lowest rank MLR 60_1, higher rank MLRs 60_2˜60_{—}n and the Main MLR (MMLR) 60′ are subsequently searched as mentioned above. As a result, if the existing VLR location information is searched, the corresponding existing Mobile Switching Center/Visitor Location Register (MSC/VLR_1) is instructed to transmit the subscriber information to the MSC/VLR_2 (step S360).

The MSC/VLR_1 receiving the request searches the call service information 42 (see FIG. 4) required for the call of the corresponding MS and then transmits the information to the MSC/VLR_2 together with the MIN and the ESN (step S370).

The MSC/VLR_2 receives the call service information and registers it in the VLR together with new location information of the mobile station (step S380).

Subsequently, in order to update the location information of the higher rank MLR connected to the MSC/VLR_2, the subscriber location information is transmitted (step S390), and this information is updated subsequently in the higher rank MLRs 60_2˜60_{—}n and the MMLR 60′ as well as the lowest MLR 60_1 connected to the MSC/VLR_2 (step S400).

Such an updating process of the location information of mobile station is accomplished identically even during the calling. Though not described in detail, in case the MS moves to another cell during the calling, the common soft handoff process generally exhibited in the existing cellular mobile telecommunication system can be adopted as it is.

Industrial Applicability

According to the mobile telecommunication system and method of the present invention described as above, loads of the home location register may be reduced by means of registering and managing location information of a mobile station in a separate middle location register. In addition, compared with the conventional telecommunication method requiring the concern of the home location register during the calling, the telecommunication method of the present invention never needs intervention of the home location register and catches the location information of the mobile station using the middle location register for connecting a call, thereby reducing the call connection time.

Furthermore, the home location register saves its energy and is thus capable of providing separate supplementary service in addition to the basic call function since it is free from the location information management and the call function.

Moreover, in the fact that the middle location registers are integrated in a hierarchical structure, the middle location registers may be sufficiently used to construct separate location information service in connection to a local hierarchical structure.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A mobile telecommunication system using separate subscriber location information comprising:
a Base station Transceiver System (BTS) (20) for wireless communication with a Mobile Station (MS) (10) by encoding and decoding of wireless channel and a Base Station Controller (BSC) (30) for operating and controlling the BTS;
a Mobile Switching Center (MSC) (40) connected to the BSC (30) for an exchanging function and establishing a path for a call by network interworking and a Visitor Location Register (VLR) (40) for exchanging information with the MSC and temporarily storing subscriber location information and call service information of the MSs existing in a service area;
a Home Location Register (MLR) (50) connected to the MSC/VLR (40) for storing service profiles of all registered subscribers; and
a Middle Location Register (MLR) (60) connected to the MSC/VLR (40) for storing subscriber location information of the MS received from the VLR,
wherein, when a call signal of the MS is received, the MSC/VLR (40) requests the subscriber location information to the MLR and then connects a call using the received subscriber location information.

2. A mobile telecommunication system using separate subscriber location information according to claim 1, wherein the MLR (60) includes:
a lowest rank MLR (60_1) connected to a plurality of the VLRs for receiving and storing the subscriber location information from the VLRS; and
a next higher rank MLR (60_2) connected to a plurality of the lowest rank MLRs (60_1) for receiving and storing the subscriber location information,
wherein the MLR (60) has a plurality of hierarchical structures from the next higher rank MLR (60_2) to an uppermost rank MLR (60_{—}n) in the same way, and the uppermost rank MLRs (60_{—}n) are connected to a Main MLR (MMLR) (60′).

3. A mobile telecommunication system using separate subscriber location information according to 1 or 2,
wherein the subscriber location information of the MLR includes a Mobile Identification Number (MIN), an Electronic Serial Number (ESN) of the MS and location information of the VLR.

4. A mobile telecommunication method using a mobile telecommunication system including a Base station Transceiver System (BTS) for wireless communication with Mobile Stations (MS), a Mobile Switching Center/Visitor Location Register (MSC/VLR) for conducting an exchanging function with the MS via the BTS and storing information of the MSs, a Home Location Register (HLR) for storing service profiles of all registered subscribers, and a Middle Location Register for storing subscriber location information of the MS, the mobile telecommunication method comprising the steps of:
(a) transmitting the subscriber location information from the MSC/VLR to the MLR and storing the subscriber location information;
(b) sending a call signal for an opponent Mobile Station (MS_2) from one Mobile Station (MS_1) via the BTS to one Mobile Switching Center/Visitor Location Register (MSC/VLR_1);
(c) requesting subscriber location information of the MS_2 from the MSC/VLR_1 to the MLR;
(d) the MLR searching the subscriber location information of the MS_2 and providing the subscriber location information to the MSC/VLR_1 in response to the request;
(e) the MSC/VLR_1 transmitting a call signal to an opponent Mobile Switching Center/Visitor Location Register (MSC/VLR_2) according to the subscriber location information;
(f) the MSC/VLR_2 calling the MS_2; and
(g) making a call with the MS_1 when the MS_2 answers while the MSC/VLR_1 is connected with the MSC/VLR_2.

5. A mobile telecommunication method using a mobile telecommunication system according to claim 4, wherein the step (a) includes:
(a1) transmitting a location registration message from the MS via the BTS to the MSC/VLR;
(a2) requesting subscriber information from the MSC/VLR to the HLR;
(a3) the HLR searching and providing the corresponding subscriber information to the MSC/VLR;
(a4) storing subscriber location information and call service information of the MS in the VLR;
(a5) transmitting the subscriber location information from the VLR to the MLR; and
(a6) storing the subscriber location information transmitted from the MLR.

6. A mobile telecommunication method using a mobile telecommunication system according to claim 4, wherein the step (a) includes:
(a1′) transmitting a location registration message from the MS via the BTS to the MSC/VLR;
(a2′) requesting subscriber information from the MSC/VLR to the HLR;
(a3′) the HLR notifying the MSC/VLR that there is no subscriber information;
(a4′) requesting subscriber information from the MSC/VLR receiving the notice to a subscribing area HLR;
(a5′) the subscribing area HLR searching and providing the corresponding subscriber information to the MSC/VLR;
(a6′) storing subscriber location information and cal service information of the MS in the VLR;
(a7′) transmitting the subscriber location information from the VLR to the MLR; and
(a8′) storing the subscriber location information transmitted from the MLR.

7. A mobile telecommunication method using a mobile telecommunication system according to claim 5 or 6, wherein the MLR includes:
a lowest rank MLR (60_1) connected to a plurality of the VLRs for receiving and storing the subscriber location information from the VLRs; and
a next higher rank MLR (60_2) connected to a plurality of the lowest rank MLRs (60_1) for receiving and storing the subscriber location information,
wherein the MLR (60) has a plurality of hierarchical structures from the next higher rank MLR (60_2) to an uppermost rank MLR (60_{—}n) in the same way, and the uppermost rank MLRs (60_{—}n) are connected to a Main MLR (MMLR) (60′),
wherein, in the step (a6 or a8′) of storing the subscriber location information transmitted from the MLR, the transmitted subscriber location information is stored subsequently from the lowest rank MLR (60_1), to which the corresponding VLR belongs, to the MMLR (60′).

8. A mobile telecommunication method using a mobile telecommunication system according to claim 7,
wherein the step (d) searches subsequently from the lowest rank MLR (60_1) to the MMLR (60′) until finding out the subscriber location information.

9. A mobile telecommunication method using a mobile telecommunication system according to claim 4,
wherein the subscriber location information stored in the MLR includes a Mobile Identification Number (MIN), an Electronic Serial Number (ESN) of the MS and location information of the VLR.

10. A mobile telecommunication method using a mobile telecommunication system according to claim 4, in case the MS moves from one Base station Transceiver System (BTS_1) to a new Base station Transceiver System (BTS_2), further comprising the steps of:
transmitting information of the MS received in the BTS_2 to the MSC/VLR; and
updating the subscriber location information of the VLR according to the transmitted information.

11. A mobile telecommunication method using a mobile telecommunication system according to claim 4, in case the MS moves from one Base station Transceiver System (BTS_1) to a new Base station Transceiver System (BTS_2), further comprising the steps of:
transmitting information of the MS received in the BTS_2 to a new Mobile Switching Center/Visitor Location Register (MSC/VLR_2);
the MSC/VLR_2 requesting subscriber information to the MLR;
the MLR searching the existing location information of the VLR for the MS;
instructing the existing Mobile Switching Center/Visitor Location Register (MSC/VLR_1) to transmit the subscriber information according to the location information of the VLR;
transmitting the subscriber information from the MSC/VLR_1 to the MSC/VLR_2 according to the instruction;
storing new subscriber location information and call service information of the MS in the new Visitor Location Register (VLR_2) according to the transmitted information; and
transmitting the new subscriber location information from the VLR_2 to the MLR and updating the subscriber location information.
